(19) United States
(12) Patent Application Publication
(10) Pub. No.: US 2014/0289033 A1
(43) Pub. Date: Sep. 25, 2014

(54) Methods and Systems for Uploading, Trading and Exchanging Loyalty Points on Social Media Websites

(71) Applicant: Ricardo Alonso Ortigoza, Brampton (CA)

(72) Inventor: Ricardo Alonso Ortigoza, Brampton (CA)

(21) Appl. No.: 13/847,257

(22) Filed: Mar. 19, 2013

(51) Int. Cl. G06Q 50/00; G06Q 30/02

(52) U.S. Cl. CPC G06Q 50/01; G06Q 30/0228
USPC 705/14.29; 705/14.27

(57) ABSTRACT

A method and system are provided for providing a plurality of loyalty programs for a plurality of merchants. This involves storing, on a computer-readable storage module, identification information for merchants and customers, and a plurality of rule sets for each merchant, receiving, a request from a customer identifying a customer, a merchant, and purchase information regarding a purchase made by a customer from a merchant, determining if the request complies with the corresponding rule set for the merchant, and, if so, determining a social media profile for the customer, awarding loyalty points to the customer, and uploading loyalty point reward information to the social media profile for the customer.

This application claims priority to U.S. Patent Application No. 61/613,421 filed on Mar. 20, 2012, the complete disclosure of which is incorporated herein by reference.

### FIELD

The described embodiments relate to systems and methods for providing customer loyalty point information on social media websites.

### INTRODUCTION

Merchants operate customer loyalty programs to reward and build customer loyalty. In a typical customer loyalty program, a customer is awarded loyalty points when they purchase goods or services from the merchant. Customer loyalty programs can be implemented in any number of ways. For example, the quantity of loyalty points awarded and the redemption value of such loyalty points often differs significantly from merchant to merchant.

### SUMMARY

In accordance with an embodiment of the invention, there is provided a method of providing a plurality of loyalty programs for a plurality of merchants. The method comprises: storing on a computer-readable storage module, identification information for a plurality of merchants and a plurality of customers, and a plurality of rule sets for the plurality of merchants such that each merchant in the plurality of merchants has a corresponding rule set defining a corresponding loyalty program for that merchant. The method also comprises receiving, at a communication module linked for communication with the computer-readable storage module, a request from a customer in the plurality of customers, wherein the request identifies the customer, a merchant in the plurality of merchants, and purchase information regarding a purchase made by that customer from that merchant. The method also comprises operating a processor to determine if the request received by the customer complies with the corresponding rule set for that merchant, the processor being linked to the communication module and the computer-readable storage module for communication therewith; if the processor determines that the request complies with the rule set, then operating the processor to determine a social media profile for the customer, and awarding loyalty points to the customer based on at least the purchase information, and uploading loyalty point reward information to the social media profile for the customer, wherein the uploaded loyalty point reward information is viewable at the social media profile for the customer.

In some embodiments, the method can also include: storing on the computer-readable storage module, a plurality of social media records for the plurality of customers such that each customer in the plurality of customers has a corresponding social media record in the plurality of social media records, and the corresponding social media record identifies a social media profile identifier, wherein operating the processor to determine the social media profile for the customer comprises locating the corresponding social media record for that customer.

In some embodiments, each rule set in the plurality of rule sets can include a social media platform rule defining at least one social media platform, and operating the processor to determine if the request received from the customer complies with the corresponding rule set for that merchant comprises determining if the social media profile record for that customer identifies a social media platform identified by the social media platform rule.

In some embodiments, each rule set in the plurality of rule sets can further include a trading rule defining when loyalty points for that merchant may be traded for loyalty points of a second merchant in the plurality of merchants awarded to a second customer in the plurality of customers.

In some embodiments, the trading rule for that merchant requires the second customer to have a social media profile identified by the social media platform rule for that merchant.

In some embodiments, the trading rule for that merchant requires the purchase information to be displayed at the social media profile for both the customer and the second customer after the trade is completed.

In some embodiments, the purchase information comprises product information for a product purchased by the customer from the merchant, the product information being uploaded and viewable at the social media profile for the customer.

In some embodiments, the product information comprises a picture of the product purchased by the customer, and the picture of the product is viewable at the social media profile for the customer.

In some embodiments, the method can also include: receiving a search request identifying at least one of a product, and a customer in the plurality of customers, and operating the processor to search for a social media profile identifying at least one of the product and the customer.

In some embodiments, the search request identifies both the product, and the customer in the plurality of customers, and operating the processor to search for the social media profile identifying at least one of the product and the customer comprises operating the processor to search for the social media profile identifying the product and the customer.

In some embodiments, the method can also include: maintaining the loyalty point reward information uploaded and viewable at the social media profile for the customer for a pre-determined time.

In some embodiments, the method can also include: storing on the computer-readable storage module, identification information for the plurality of merchants and the plurality of customers. The step of storing identification information for the plurality of merchants and the plurality of customers comprises: storing on the computer-readable storage module, identification information for a plurality of unique merchant identifiers for the plurality of merchants such that each merchant in the plurality of merchants has a corresponding unique merchant identifier; and storing on the computer-readable storage module, a plurality of unique customer identifiers for a plurality of customers such that each customer in the plurality of customers has a corresponding unique customer identifier

In some embodiments, the method can also include receiving a social media album request identifying at least a customer in the plurality of customers and a merchant in the plurality of merchants, operating the processor to generate a social media album wherein the social media album contains a picture for each of one or more products purchased from the merchant by the customer, and uploading the social media album to the social media profile of the customer.

In accordance with an embodiment of the invention, there is provided a computer system for providing a plurality of loyalty programs for a plurality of merchants. The computer system comprising: a computer-readable storage module configured to store identification information for a plurality of merchants and a plurality of customers, and a plurality of rule sets for the plurality of merchants such that each merchant in the plurality of merchants has a corresponding rule set defining a corresponding loyalty program for that merchant, the computer readable storage module being configured to store the identification record for that merchant in linked relation with the corresponding rule set for that merchant such that the corresponding rule set can be determined from the identification information for that merchant; a communication module linked for communication with the computer-readable storage module, the communication module being configured to receive a request from a customer in the plurality of customers, wherein the request identifies the customer, a merchant in the plurality of merchants, and purchase information regarding a purchase made by that customer from that merchant; a processor configured to determine if the request received by the customer complies with the corresponding rule set for that merchant, the processor being linked to the communication module and the computer-readable storage module for communication therewith; wherein if the processor determines that the request complies with the rule set, then the processor is further configured to determine a social media profile for the customer, and award loyalty points to the customer based on at least the purchase information, and upload loyalty point reward information to the social media profile for the customer, wherein the uploaded loyalty point reward information is viewable at the social media profile for the customer.

In some embodiments, the computer-readable storage module is further configured to store a plurality of social media records for the plurality of customers such that each customer in the plurality of customers has a corresponding social media record in the plurality of social media records, and the corresponding social media record identifies a social media profile identifier, wherein the processor is configured to locate the corresponding social media record for that customer when determining the social media profile for the customer.

In some embodiments, each rule set in the plurality of rule sets includes a social media platform rule defining at least one social media platform, and the processor is configured to determine if the social media profile record for that customer identifies a social media platform identified by the social media platform rule when determining if the request received from the customer complies with the corresponding rule set for that merchant.

In some embodiments, each rule set in the plurality of rule sets further includes a trading rule defining when loyalty points for that merchant may be traded for loyalty points of a second merchant in the plurality of merchants awarded to a second customer in the plurality of customers.

In some embodiments, the trading rule for that merchant requires the second customer to have a social media profile identified by the social media platform rule for that merchant.

In some embodiments, the trading rule for that merchant requires the purchase information to be displayed at the social media profile for both the customer and the second customer after the trade is completed.

In some embodiments, the purchase information comprises product information for a product purchased by the customer from the merchant, the product information being uploaded and viewable at the social media profile for the customer.

In some embodiments, the product information comprises a picture of the product purchased by the customer, and the picture of the product is viewable at the social media profile for the customer.

In some embodiments, the communication module is further configured to receive a search request identifying at least one of a product, and a customer in the plurality of customers, and the processor is further configured to search for a social media profile identifying at least one of the product and the customer.

In some embodiments, the search request identifies both the product, and the customer in the plurality of customers, and the processor is further configured to search for the social media profile identifying at least one of the product and the customer.

In some embodiments, the processor is further configured to maintain the loyalty point reward information uploaded and viewable at the social media profile for the customer for a pre-determined time.

In some embodiments, the computer-readable storage module is configured to store identification information for the plurality of merchants and the plurality of customers comprising a plurality of unique merchant identifiers for the plurality of merchants such that each merchant in the plurality of merchants has a corresponding unique merchant identifier; and a plurality of unique customer identifiers for a plurality of customers such that each customer in the plurality of customers has a corresponding unique customer identifier.

In some embodiments, the communication module is further configured to receive a social media album request identifying at least a customer in the plurality of customers and a merchant in the plurality of merchants, and the processor is further configured to generate a social media album wherein the social media album contains a picture for each of one or more products purchased from the merchant by the customer, and to upload the social media album to the social media profile of the customer.

### DRAWINGS

FIG. 1 is a block diagram illustrating a system for uploading, trading and exchanging loyalty points on social media websites, in accordance with at least one embodiment;

FIG. 2 is a schematic illustration of a device used in the system of FIG. 1, in accordance with at least one embodiment;

FIG. 3A illustrates an example customer record, in accordance with at least one embodiment.

FIG. 3B illustrates an example merchant record, in accordance with at least one embodiment.

FIG. 3C illustrates an example rule set record, in accordance with at least one embodiment.

FIG. 3D illustrates an example social media record, in accordance with at least one embodiment.

FIG. 3E illustrates an example upload record, in accordance with at least one embodiment.

FIG. 3F illustrates an example trade record, in accordance with at least one embodiment.

FIG. 4 is a flowchart illustrating a method of uploading customer loyalty program data to a social media website, in accordance with at least one embodiment;

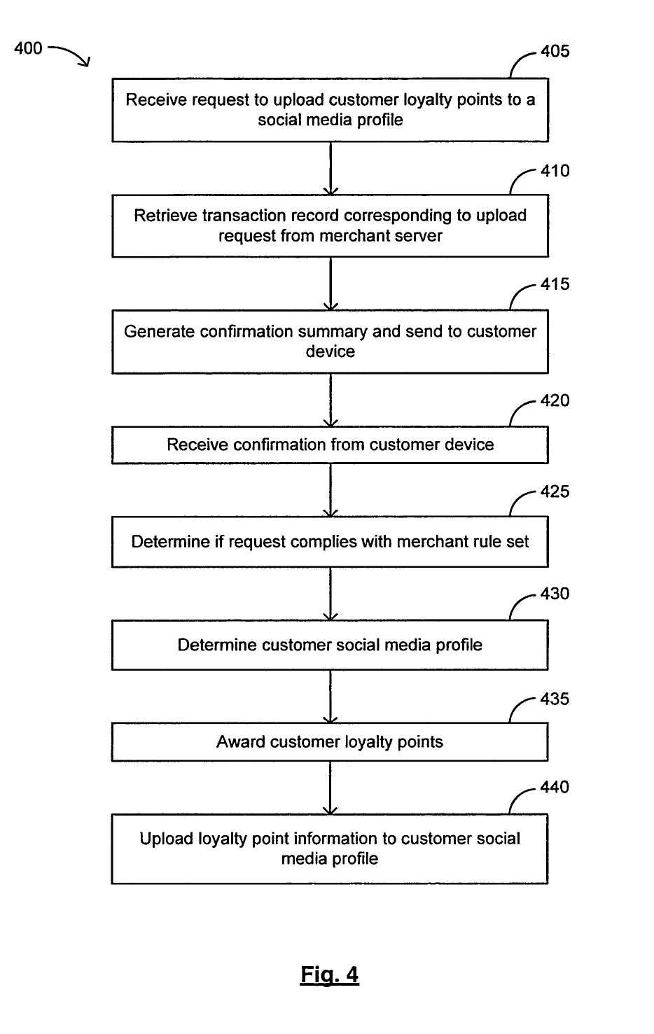

FIG. 5 shows a flowchart illustrating a method of transferring loyalty points between two customers, in accordance with at least one embodiment;

FIG. 6 is a flowchart illustrating a method of exchanging loyalty points between two customer loyalty programs, in accordance with at least one embodiment;

FIG. 7 is a screen capture of a graphical user interface (GUI) that can be displayed on a display of a device, in accordance with at least one embodiment;

FIG. 8 is a screen capture of a GUI that can be displayed on a display of a device, during a transfer of loyalty points from a first customer to a second customer, in accordance with at least one embodiment;

FIG. 9 is a screen capture of a GUI that can be displayed on a display of a device, during an exchange of loyalty points, in accordance with at least one embodiment;

FIG. 10 is a screen capture of a GUI that can be displayed on a display of a device, showing public exchange offers, in accordance with at least one embodiment; and

FIG. 11 is a screen capture of a GUI that can be displayed on a display of a device, showing a history of loyalty point exchanges, in accordance with at least one embodiment.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The embodiments of the systems, processes and methods described herein can be implemented in hardware or software, or a combination of both. Alternatively, these embodiments can also be implemented in computer programs executed on programmable computers each comprising at least one processor (e.g., a microprocessor), a data storage system (including volatile and non-volatile memory and/or storage elements), at least one input device, and at least one output device. For example and without limitation, the programmable computers (referred to below as devices) can be a personal computer, laptop, personal data assistant, cellular telephone, smart-phone device, tablet computer, and/or wireless device. For any software components, program code is applied to input data to perform the functions described herein and generate output information. The output information is applied to one or more output devices.

Each software component or program can be implemented in a high level procedural or object oriented programming and/or scripting language to communicate with a computer system. However, the programs can be implemented in assembly or machine language, if desired. In any case, the language can be a compiled or interpreted language. Each such computer program is preferably stored on a storage media or a device (e.g. ROM) readable by a general or special purpose programmable computer, for configuring and operating the computer when the storage media or device is read by the computer to perform the procedures described herein. The subject system can also be considered to be implemented as a computer-readable storage medium, configured with a computer program, where the storage medium so configured causes a computer to operate in a specific and predefined manner to perform the functions described herein.

Furthermore, the processes and methods of the described embodiments are capable of being distributed in a computer program product comprising a computer readable medium that bears computer usable instructions for one or more processors. The medium can be provided in various forms, including one or more diskettes, compact disks, tapes, chips, wireline transmissions, satellite transmissions, internet transmission or downloadings, magnetic and electronic storage media, digital and analog signals, and the like. The computer useable instructions can also be in various forms, including compiled and non-compiled code.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, this description and the drawings are not to be considered as limiting the scope of the embodiments described herein in any way, but rather as merely describing the implementation of the various embodiments described herein.

The various embodiments described herein generally relate to a system (and related methods) for uploading, transferring and exchanging loyalty points on social media websites.

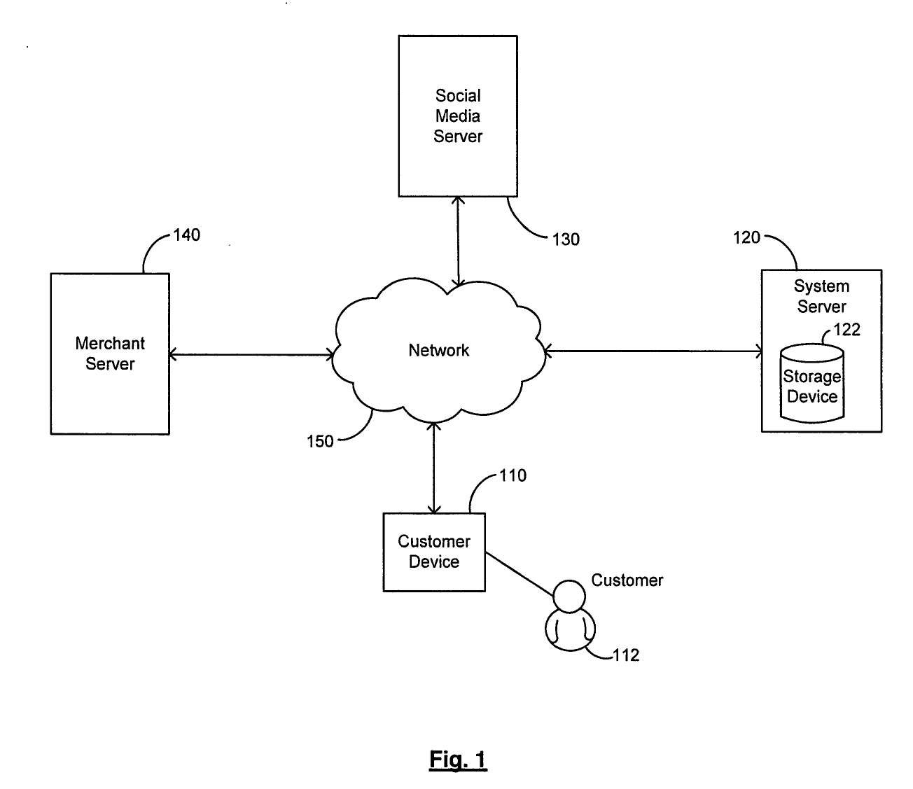

Reference is first made to FIG. 1, which illustrates a block diagram 100 of a system server 120 in communication with other components.

As shown in FIG. 1, the system server 120 can communicate with each of a customer device 110, a social media server 130 and a merchant server 140 over a network 150. Similarly, each of the customer device 110, the social media server 130 and/or the merchant server 140 can also communicate with each other over the network 150. For clarity, only one each of customer device 110, social media server 130 and merchant server 140 is illustrated in FIG. 1 but it will be understood that one or more customer devices 110, social media servers 130 and merchant servers 140 can communicate with one or more system servers 120 at any given time.

Generally, social media server 130 operates to host a social media website and store social media profiles. A social media profile may be associated with customer 112 using customer device 110 for example. The owner of a social media profile can store content such as text, images, audio and video in their social media profile. A social media profile can be accessed and operations performed thereon via a graphical user interface (GUI).

In addition, social media server 130 operates to process requests to perform operations on a social media profile. For example, requests can be received and processed by social media server 130 to add, edit or delete content contained in a social media profile. Social media server 130 can receive requests to add, edit or delete content contained in a social media profile from components of system 100 such as a customer device 110 or system server 120. For example, customer 112 can send a request to social media server 130 to post an image on their social media profile. In another example, system server 120 can send a request to social media server 130 to post a text string to a social media profile stored on social media server 130.

The content uploaded on a social media profile typically reflects the interests and activities of the owner of the social media profile. For example, customer 112 may be interested in shopping and choose to upload content pertaining to shopping experiences to their social media profile so that the information is available to their social network. Conversely, customer 112 may view the social media profiles of their social network to obtain shopping-related information such as information about the shopping experiences of others. For example, customer 112 may wish to find out, track or compare what products and/or services that members of their social network have purchased in the past and where members of their social network shop most often.

Content pertaining to the shopping experiences of customer 112 can include details such as describing where customer 112 went shopping, which merchants they visited while they were shopping, their favourite merchants and customer loyalty programs and so on. Furthermore, customer 112 can upload shopping-related content in the form of images, sounds or videos to their social media profile. For example, customer 112 can upload pictures of products that they purchased while shopping and promotional and/or merchandising materials of their favourite merchants or shopping destinations.

Typically, a social media profile can be configured to link to one or more other social media profiles stored on social media server 130. A collection of linked social media profiles can be referred to as a social network. For example, customer 112 can build a social network by linking their social media profile stored on social media server 130 to the social media profiles associated with their friends and family members also stored on social media 130. In another example, a merchant (not shown) can store a social media profile on social media server 130 for the purpose of marketing the merchant's products and services on the social media profiles that comprise the merchant's social network.

Social media websites, profiles and networks are generally viewed using a web browser. At least some of the content of a social media profile is viewable on each of the other social media profiles in a social network. Typical features provided by social media websites include dynamically generated news feeds that display the most recently added or edited social media profile content and notifications. For example, an image uploaded on one social media profile can appear on the news feed associated with each social media profile in the social network. Additionally, a notification can appear on the user interface provided by a social media website to alert a user to changes in the content of social media profiles in the user's social media network.

Social media server 130 can also store preferences associated with a social media profile. The preferences associated with a social media profile indicate how the owner of the social media profile prefers their social media profile to operate. Examples of preferences associated with a social media profile include: preferences to control the display of content in a social media profile, preferences to control who can view the social media profile (privacy preferences), and preferences to control which third-party software applications, if any, may access, upload or edit content associated with a social media profile.

Generally, merchant server 140 operates to store transaction records associated with transactions between customers and merchants. A transaction record is generated each time a customer purchases products and/or services from a merchant for example. A transaction record contains purchase information such as the name of the product or service purchased, the time of the transaction, the method of payment used, the price of the purchase and the number of loyalty points generated by the transaction.

Merchant server 140 can also store product records associated with the products and/or services that the merchant sold in a transaction record. For example, a product record can contain a description of the product and/or service purchased from that merchant by a customer, the availability of the product (for example, retail locations where a product and/or service is available for purchase and the quantity available at each retail location), pricing information, promotional information and images of the products and/or services.

Optionally, transaction records and product records can be located together. Alternatively, transaction records and product records can each reside on different merchant servers 140. For example, transaction records can be located on a server managed by a financial institution (for example, a bank, credit union or credit card company).

System server 120 operates to store identification information for a plurality of merchants and a plurality of customers and a plurality of rule sets for the plurality of merchants such that each merchant in the plurality of merchants has a corresponding rule set defining a corresponding loyalty program for that merchant. In at least one embodiment, system server 120 can store customer records containing identification information for a plurality of customers, merchant records containing identification information for a plurality of merchants, rule set records defining a plurality of customer loyalty programs corresponding to each merchant in the plurality of merchants, social media records, upload records and trade records. Collectively, records stored on system server 120 are used to provide a plurality of customer loyalty programs for a plurality of merchants. The function of each record in a customer loyalty program is discussed in more detail below.

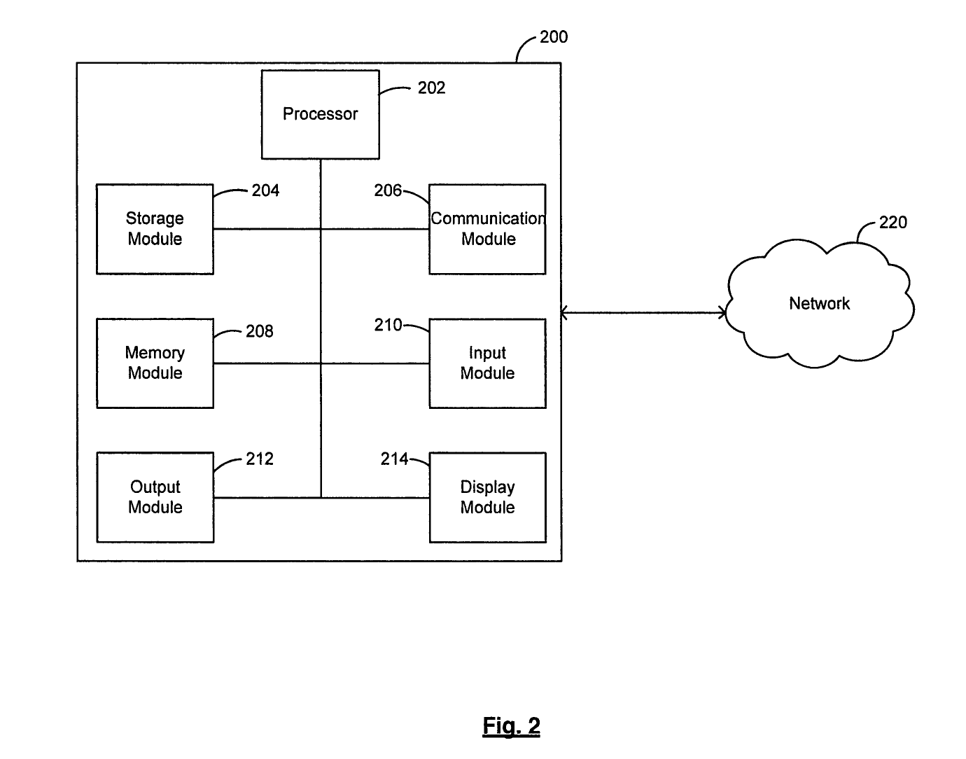

Customer device 110 can generally be any computing device capable of network communication and will be described further below in relation to FIG. 2. Customer device 110 is used by customer 112 to interact with other components in system 100. Customer device 110 can interact with other components in system 100 using a protocol such as an Application Programming Interface (API) in known fashion. Generally speaking, an API protocol is implemented by installing and/or executing software modules on the components of system 100 for example. Once installed on the components of system 100, the API software modules typically provide a syntax structure to enable the components of system 100 to send and receive instructions from other components in system 100. For example, the instructions sent between components in system 100 can include requests to retrieve data stored on system components such as system server 120, merchant server 140 or social media server 130 in the form of HTTP requests. Customer device 110 may interact with social media server 130 using the Facebook Connect API (details available at:) and may interact with merchant server 140 using the Magento API (details available at:) for example. Customer device 110 can display a graphical user interface (GUI) that customer 112 can use to interact with the components of system 100. In at least one embodiment, the GUI on customer device 110 is displayed via a social media profile using a web browser application.

The network 150 can include a local network, a mobile network and/or the internet.

FIG. 2 shows an example schematic of a device 200. As shown, device 200 is generally illustrated as having hardware components, which can be used by one or more of the elements of system 100, such as customer device 110, system server 120, social media server 130 and merchant server 140. Generally, a device 200 can be a server computer, desktop computer, notebook computer, tablet, PDA, smartphone, or another computing device. In at least one embodiment, device 200 includes a connection with a network 210 such as a wired or wireless connection to the Internet or to a private network. In some cases, network 210 includes other types of computer or telecommunication networks. Network 210 may correspond with network 150 shown in FIG. 1.

In the example shown, device 200 includes a processor 202, a storage module 204, a communication module 206, a memory module 208, an input module 210, an output module 212, and a display module 214. In some embodiments, device 200 includes multiple of any one or more of processor 202, storage module 204, communication module 206, memory module 208, input module 210, output module 212, and display module 214.

Generally, processor 202 can execute applications, computer readable instructions or programs. Applications, computer readable instructions or programs correspond with software modules including computer executable instructions to perform processing for the functions and methods described below. The applications, computer readable instructions or programs can be stored in storage module 204, memory module 208 or can be received from remote storage accessible through network 220, for example. When executed, the applications, computer readable instructions or programs can configure the processor 202 to perform the acts described herein with reference to system server 120, customer device 110, social media server 130, or merchant server 140, for example.

Communication module 206 generally provides a communication interface for device 200. Communication module 206 can include one or more communication ports and/or components for receiving data from and/or transmitting data to external components and/or devices. The communication ports can include a USB port, a serial port and/or one or more other peripheral ports. Communication module 206 can provide communication via different communication protocols, such as for example via radio-frequency, wireless, and/or Bluetooth™ communication.

Memory module 208 can include random access memory (RAM) or similar types of memory. Storage module 204 can include a hard disk drive, floppy disk drive, CD drive, DVD drive, Blu-ray drive, or other types of non-volatile data storage. Alternatively, storage module 204 can be provided as a database implementation, such as an implementation that uses Structured Query Language (SQL). It will be understood that storage module 204 can include one or more databases.

Input module 210 can include any device for entering information into device 200. For example, input module 210 can be a keyboard, key pad, cursor-control device, touch-screen, camera, or microphone. Input module 214 can also include input ports and wireless radios (e.g. Bluetooth®, or 802.11x) for making wired and wireless connections to external devices.

Output module 212 can include any type of device for presenting a hard copy of information, such as a printer for example. Output module 212 can also include other types of output devices such as speakers, for example. In at least one embodiment, output module 212 includes one or more of output ports and wireless radios (e.g. Bluetooth®, or 802.11x) for making wired and wireless connections to external devices.

Display module 214 can include any type of device for presenting visual information. For example, display module 214 can be a computer monitor, a flat-screen display, a projector or a display panel.

In some embodiments, device 200 stores information in a remote storage device, such as cloud storage, accessible across a network, such as network 220 or another network. In some embodiments, device 200 stores information distributed across multiple storage devices, such as storage module 204 and memory module 208 (i.e. each of the multiple storage device stores a portion of the information and collectively the multiple storage devices store all of the information). Accordingly, storing data in a storage module as used herein and in the claims, means storing that data in a local storage module, storing that data in a remote storage module, or storing that data distributed across multiple storage modules, each of which can be local or remote.

FIG. 2 illustrates only one example hardware schematic of a device 200. In an alternate embodiment, device 200 contains fewer, additional or different components. In addition, although aspects of an implementation of device 200 are described as being stored in storage module 204, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM.

Referring again to FIG. 1, system server 120 is shown including a storage device 122. Storage device 122 can generally correspond to storage module 204 or memory module 208 described above with reference to device 200. Furthermore, storage device 122 can be locally connected to system server 120, or located remotely across a local network (e.g. in network attached storage (NAS)) or the Internet (e.g. in cloud storage).

Although FIG. 1 shows one storage device 122, in some embodiments, system server 120 includes multiple storage devices 122. Each of the multiple storage devices 122 can be located locally or remotely. For clarity, various aspects are described below as being stored on storage device 122. However, in variant embodiments, these aspects can be stored on one or more of multiple storage devices (not shown) which are accessible to system server 120. For example, some aspects can be stored on a local storage device, some aspects can be stored on a remote storage device, and some aspects can be stored in part on the local storage device and in part on the remote storage device.

As will be described in detail below, system server 120 can store a plurality of customer records 310, merchant records 320, rule set records 330, social media records 340, upload records 350 and trade records 360. The pluralities of records can be stored as discrete files or as entries in a database, in storage device 122 for example.

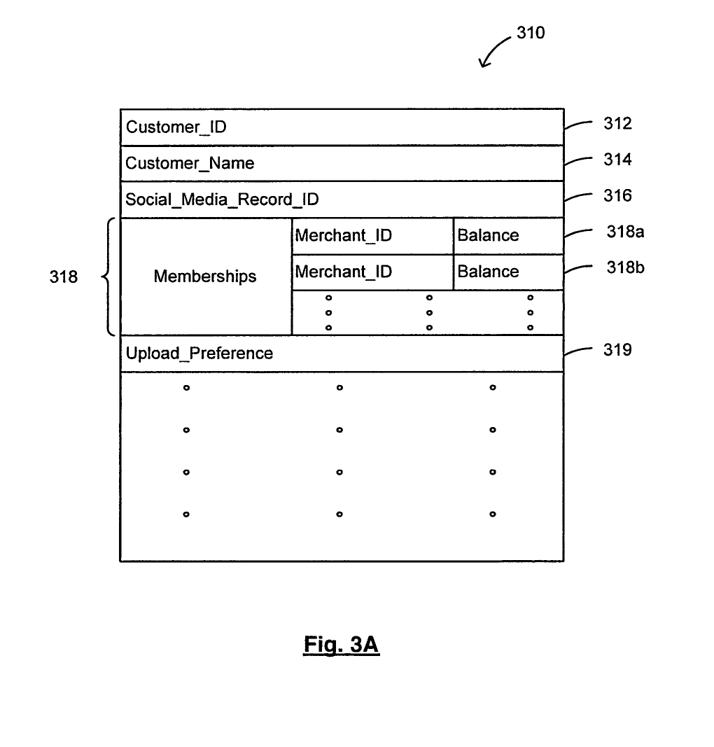

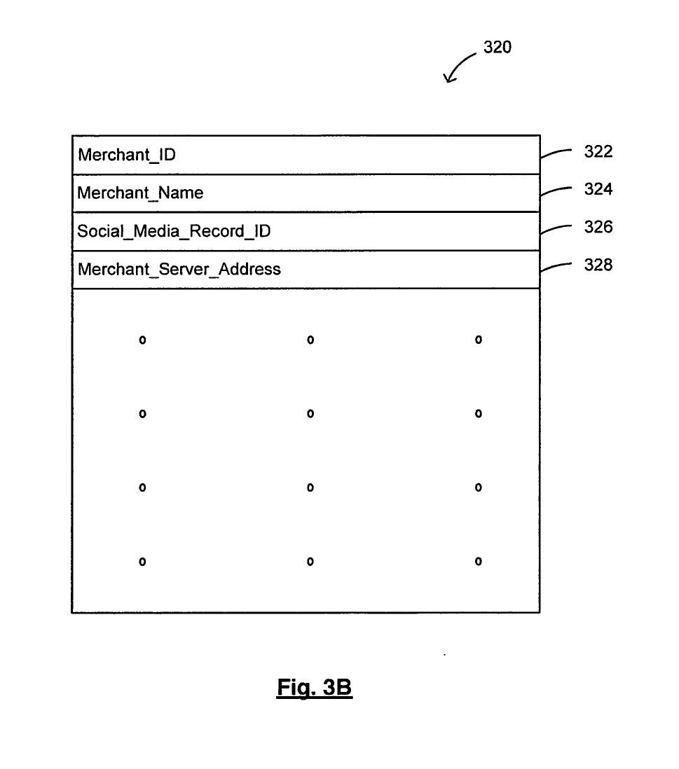

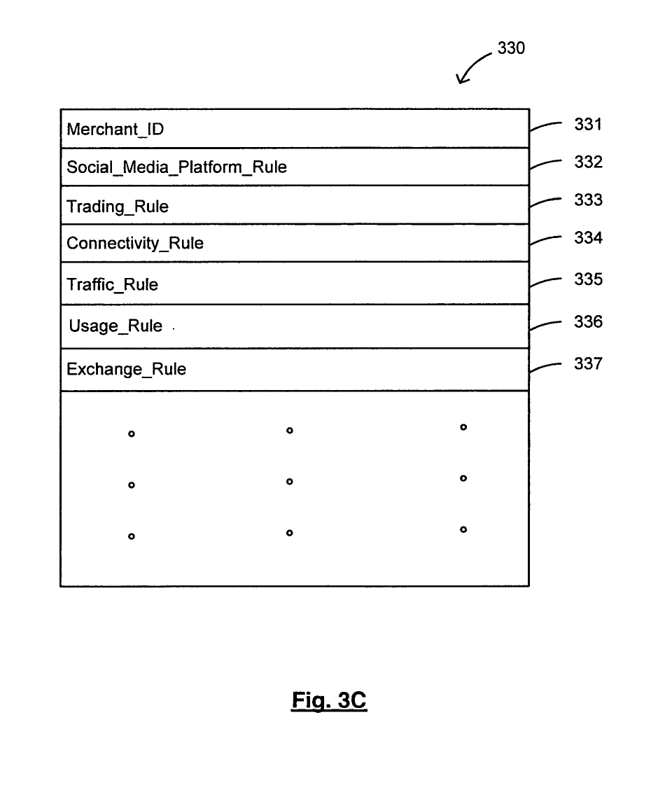

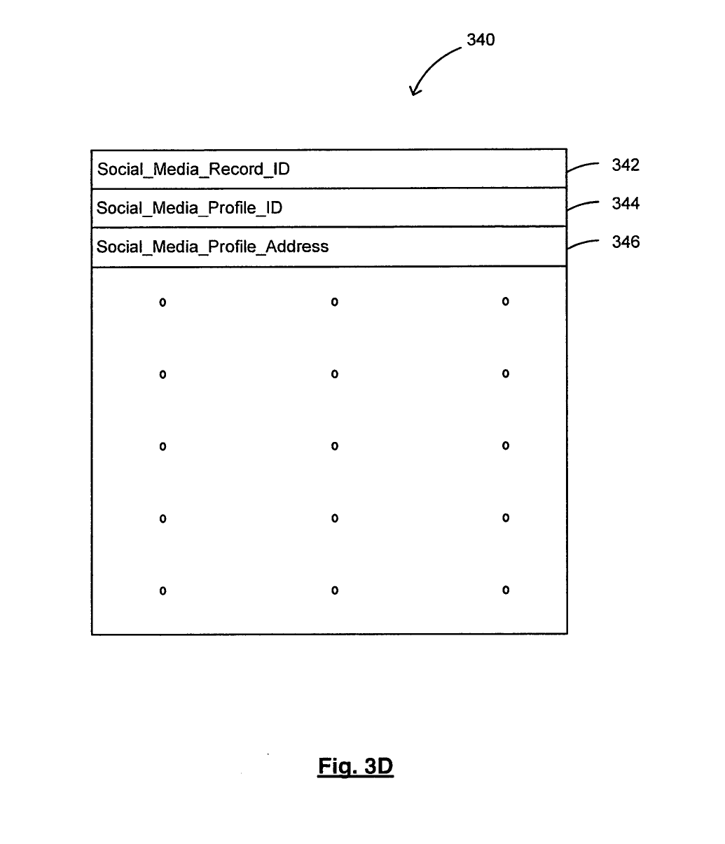

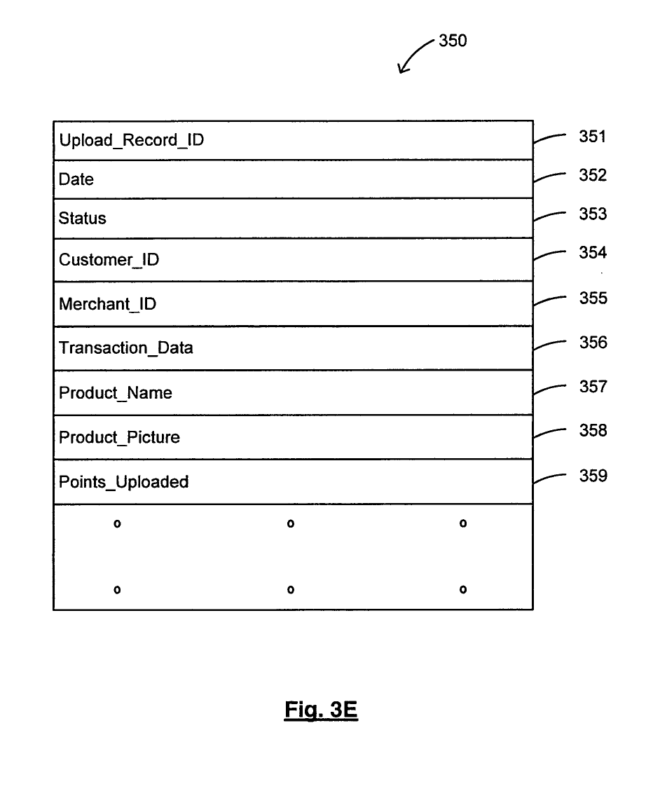

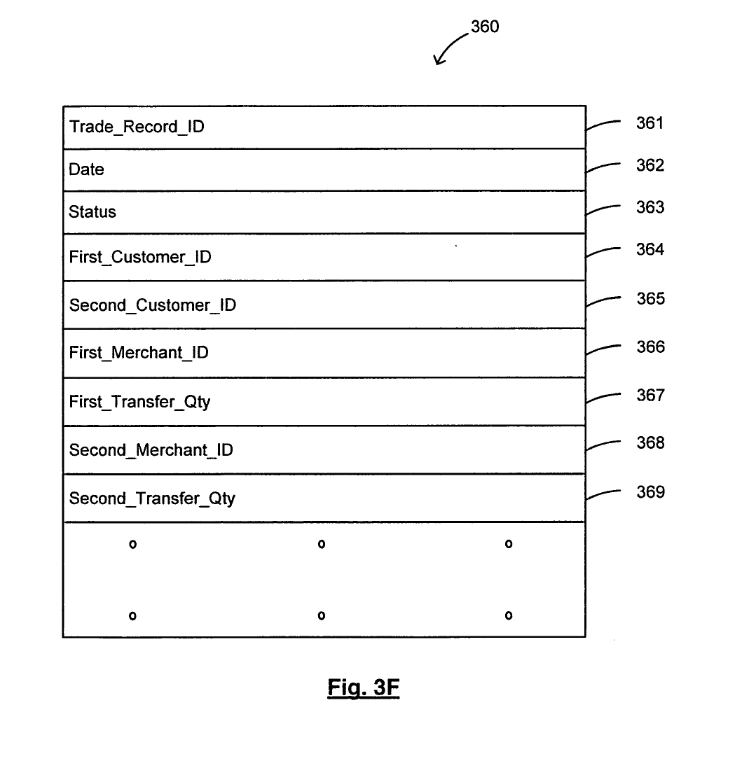

Reference is now made to FIGS. 1, and 3A. FIG. 3A shows a customer record 310 in accordance with at least one embodiment. Each customer record 310 contains information about a customer enrolled in one or more customer loyalty programs. In the example shown, customer record 310 includes a customer ID 312 indicating a customer identifier, a customer name 314 indicating a customer name a customer social media record ID 316, indicating a social media record identifier, and memberships 318, indicating membership in one or more customer loyalty programs. Each element in customer record 310 can take any suitable form such as a text string, an integer value or a uniform resource locator (URL) for example.

In at least one embodiment, customer record 310 further contains an upload preference 319. Upload preference 319 allows customer 112 to indicate their consent for system server 120 to automatically upload content to their social media profile. For example, upload preference 319 may be configured by customer 112 to permit system server 120 to automatically upload all loyalty point information to their social media profile. In another example, upload preference 319 may be configured by customer 112 to permit system server 120 to automatically upload loyalty point information from some (but not all) customer loyalty programs to their social media profile.

In different embodiments, customer record 310 can include additional or fewer elements. For example, customer record 310 can additionally include a customer's marital status (not shown) and record 310 can omit customer name 312. Furthermore, customer record 310 can include multiples of each element. In this example, customer record 310 contains two memberships 318 (318a and 318b). As shown, each membership within memberships 318 records a merchant identifier that indicates which customer loyalty program the customer is enrolled in and a loyalty points balance.

Typically, system server 120 generates and stores customer record 310 in response to a signup request received from a customer device 110. For example, customer 112 can input information on a signup form displayed on customer device 110 and submit the signup request to system server 120. Upon receipt of the signup request, system server 120 generates customer record 310 and stores the information provided in the completed signup form in the newly created customer record 310. In at least one embodiment, system server 120 generates unique customer ID 312 and associates it with the customer record 310 of customer 112.

Reference is now made to FIGS. 1 and 3B. FIG. 3B shows a merchant record 320 in accordance with at least one embodiment. Each merchant record 320 stores information about a merchant operating a customer loyalty point program. In the example shown, merchant record 320 includes a merchant ID 322 indicating a merchant identifier, a merchant name 324 indicating a merchant name, a social media record ID 326, indicating a social media record identifier associated with the merchant and a merchant server address 328. Each of merchant ID 322, merchant name 324, social media record ID 326 and merchant server address 328 can take any suitable form such as a text string, an integer value or a uniform resource locator (URL) for example. In different embodiments, merchant record 320 can include additional or fewer elements. For example, merchant record 320 can additionally include a merchant phone number (not shown) and merchant record 320 can omit merchant name 324.

Typically, system server 120 generates and stores merchant record 320 in response to a signup request received from a merchant server 140. For example, a merchant can input information on a signup form displayed on merchant server 140 and submit the signup request to system server 120. Upon receipt of the signup request, system server 120 generates merchant record 320 and stores the information provided in the completed signup form in the newly created merchant record 320. In at least one embodiment, system server 120 generates unique merchant ID 322 and associates it with merchant record 320.

Reference is now made to FIGS. 1 and 3C. FIG. 3C shows a rule set record 330 in accordance with at least one embodiment. Each rule set record 330 contains rules that define a customer loyalty program. In the example shown, rule set record 330 includes a merchant ID 331 indicating a merchant identity, a social media platform rule 332 indicating a social media platform rule, a trading rule 333 indicating a trading rule, a connectivity rule 334 indicating a connectivity rule, a traffic rule 335 indicating a traffic rule a usage rule 336, indicating a usage rule and an exchange rule 337, indicating an exchange rule. In some embodiments, rule set record 330 can include additional or fewer rules. For example, rule set record 330 can additionally include a promotion rule (not shown) and rule set record 330 can omit connectivity rule 334, or any of the other above-listed rules provided it includes at least one rule.

Each rule set record 330 is linked to a corresponding merchant record 320. For example, merchant identifier 322 in merchant record 320 corresponds with merchant identifier 331 in rule set record 330 so that the rule set record corresponding with a merchant can be easily retrieved by system server 120.

A merchant can configure the rules contained in rule set record 330 to administer their customer loyalty program in any number of ways. As mentioned above, merchants may store a relatively small amount of rules in rule set record 330. Alternatively, merchants may store a large number of rules to define a more sophisticated customer loyalty program.

Upon receipt of requests from customer devices 110 to upload, transfer or exchange loyalty points associated with customer loyalty programs, system server 120 can retrieve the corresponding rule set record 330 to determine how the request is to be processed. For example, system server 120 can decide if a request should be granted or denied based on the rules contained in rule set record 330.

In at least one embodiment, a merchant can configure the social media platform rule 332 to prevent customers without a social media profile, or at least an acceptable social media profile on an acceptable social media platform, from uploading, trading or exchanging loyalty points.

In at least one embodiment, a merchant can configure trading rule 333 to configure trading of loyalty points. As will be described in detail below, trading rule 333 can be configured to define how loyalty points can be transferred to other customers or exchanged for loyalty points of customer loyalty programs or a combination of both. Specifically, merchants can use trading rule 333 to permit, forbid or limit trading of loyalty points. In one example, a merchant can choose to permit the exchange of loyalty points awarded by the merchant for loyalty points of other customer loyalty programs established by other merchants, and trading rule 333 can then be configured to reflect this. In another example, a merchant wishing to permit the exchange of loyalty points into loyalty points of other customer loyalty programs excepting those customer loyalty programs of the merchant's competitors can configure trading rule 333 to record the customer loyalty programs which are acceptable to the merchant.

Merchants can further configure rules such as connectivity rule 334, traffic rule 335 and usage rule 336 in rule set records 330 to help prevent or limit trading of loyalty points where sending or receiving customers appear to be using bogus social media profiles.

In at least one embodiment, a merchant can configure a social media connectivity rule 334 to define a minimum level of connectivity that a social media profile must possess to be considered legitimate. Connectivity can be measured by the number of connections a social media profile has to other social media profiles (i.e. the size of a social network). A lower number of connections can suggest that the profile is not genuine whereas a large number of connections is suggestive of a legitimate social media profile. In one example, the connectivity rule is 10 connections. Accordingly, to satisfy the connectivity rule a social media profile must have 10 or more connections.

In at least one embodiment, a merchant can configure a social media traffic rule 335 to define a minimum level of traffic that a social media profile must possess to be considered legitimate. Traffic can be measured by the number of times or how frequently a social media profile is viewed by members of the social network. A social media profile is more likely to be considered legitimate where it is viewed frequently or has been viewed a large number of times.

In at least one embodiment, a merchant can configure a social media usage rule 336 to define a minimum level of usage that a social media profile must possess to be considered legitimate. Usage quantifies the number of times a social media profile is accessed by the owner of the social media profile. The usage rating is typically useful to determine legitimacy in cases where a social media profile has a lower volume of connections or traffic.

System server 120 can retrieve connectivity, traffic or usage data by referencing one or more local or remote sources (for example, any of the components of system 100). In an embodiment, system server 120 can refer to social media server 130 to retrieve the connectivity, traffic or usage data associated with a social media profile. For example, system server 120 can reference social media server 130 to determine the number of connections a social media profile has and thus determine the corresponding level of connectivity for the social media profile. Furthermore, in an alternative embodiment, system server 120 can be configured to determine and store connectivity, traffic and usage data associated with a customer or the customer's social media profile. For example, system server 120 can determine connectivity, traffic and usage ratings for each social media profile based on the number of times customer 112 sends a request to system server 120 to upload loyalty point data or trade loyalty points and store such ratings in customer record 310.

In some embodiments, in addition to using rules such as connectivity rule 334, traffic rule 335 and usage rule 336 in rule set records 330 to restrict or prevent trading, merchants can also use the rules stored in rule set records 330 to award loyalty points to customers that have social media profiles with high levels of connectivity, traffic or usage. For example, a merchant may engage in promotional activities in which customers enrolled in the merchant's customer loyalty program are awarded a number of loyalty points based on the number of social media profile connections the customer social media profile has.

In at least one embodiment, a merchant can configure an exchange rule 337 to define a monetary value for the loyalty points issued from merchant's customer loyalty program. For example, a first merchant may set their associated exchange rule 337 to specify that $1 of customer spend equals 1 loyalty point while a second merchant may set their associated exchange rule 337 to specify that $1 of customer spend is worth 10 loyalty points. As will be described below, system server 120 can use exchange rule 337 to calculate the quantity of loyalty points to be awarded to a customer based on transaction data or to determine if an exchange of loyalty points between a first and second customer may proceed.

Reference is now made to FIGS. 1 and 3D. FIG. 3D shows a social media record 340 in accordance with at least one embodiment. Social media record 340 contains parameters that enable system server 120 to retrieve a social media profile associated with a customer or merchant using system 100 from social media server 130. Each customer record 310 and merchant record 320 is linked with a corresponding social media record 340. For example, social media record ID 316 in customer record 310 and social media record ID 326 in merchant record 320 corresponds with social media record ID 342 in social media record 340 so that the social media record corresponding with a customer or merchant can be easily retrieved by system server 120.

In the example shown, social media record 340 includes at least a record ID 342 and a social media profile ID 344. Each element in social media record 340 can take any suitable form such as a text string, an integer value or a uniform resource locator (URL) for example. It will be understood that social media record 340 can include additional elements. For example, social media record 340 can include a plurality of social media profile ID 314 where a customer or merchant has more than one social media profile.

Reference is now made to FIGS. 1 and 3E. FIG. 3E shows an upload record 350 in accordance with at least one embodiment. An upload record 350 stores details of loyalty points uploaded to social media profiles by system server 120.

In the example shown, upload record 350 includes at least an identifier 351, a date 352, a status indicator 353, a customer identifier 354, a merchant identifier 355, transaction data 356, a product name 357, a product picture 358 and an indication of the quantity of loyalty points uploaded 359.

In different embodiments, upload record 350 can include additional or fewer elements. For example, upload record 350 can additionally include a product description (not shown) and record 350 can omit date 352.

Reference is now made to FIGS. 1 and 3F. FIG. 3F shows a trade record 360 in accordance with at least one embodiment. A trade record 360 contains parameters that enable system server 120 to track loyalty points that have been traded.

Trading can be either a transfer of loyalty points or an exchange of loyalty points. A transfer of loyalty points involves transferring the ownership of loyalty points from a first customer to a second customer. An exchange of loyalty points involves exchanging loyalty points from a first merchant loyalty program into points of a second merchant loyalty program. An exchange of loyalty points may involve a transfer of loyalty points for one loyalty program from a first customer to a second customer, and a corresponding transfer of loyalty points for one loyalty program from the second customer to the first customer. However, more than one customer may also be involved, such that at least one customer in the transfer receives loyalty points from a different customer than the customer to whom she transfers loyalty points. Optionally, a merchant may also be recorded as a customer.

Of course, different philosophies for how available loyalty point trading can prevail in different situations. For example, some merchants, or some operators of customer loyalty programs, may want to restrict trading of loyalty points of their customer loyalty program using the social media platform, trading, connectivity, traffic and usage rules described above. However other merchants, or operators of customer loyalty programs, may want to encourage as many trades of loyalty points as possible, and thus may impose as few restrictions as possible. In embodiments of the present invention according to this alternative philosophy, rules such as the social media platform rule, trading rule, connectivity rule, the traffic rule or the usage rule may simply be dropped to make it easier for customers to trade loyalty points.

In the example shown, trade record 360 includes a trade record identifier 361, a date 362, a status 363, a first customer identifier 364, a second customer identifier 365, a first merchant identifier 366, and a first indication of a quantity of loyalty points to be traded 367. In addition, trade record 360 contains an identifier for a second merchant 368 and a second indication of a quantity of loyalty points to be traded 369.

In at least one embodiment, system server 120 can receive a request to search upload records 350 and trade records 360. A search request can include at least an indication of a product and a customer. Upon receipt of a search request, system server 120 retrieves any upload records 350 and trade records 360 that match the product and/or customer parameters provided in the search request.

System server can further generate search results that display the any or all of the contents of the retrieved upload and/or trade records that match the criteria provided in the search request. For example, in response to a search request specifying “Starbucks” as the product name, system server 120 inspects, for example, the product name 357 field of each upload record 350. System server 120 returns some or all of the contents of upload records 350 that match the search request. For example, system server 120 can display each upload record that matches the search request in its entirety, or, display the elements of upload record 350 that are the most relevant such as the date 352 of the upload, the status of the upload 353, the customer ID 354, the product name 357 and product picture 358. In at least one embodiment, system server 120 may refine search results by referencing data stored on one or more local or remote sources such as any of the components of system 100. For example, system server 120 can cross-reference search results against data from social media server 130 to identify search results that pertain to the requesting customer's social media profile connections.

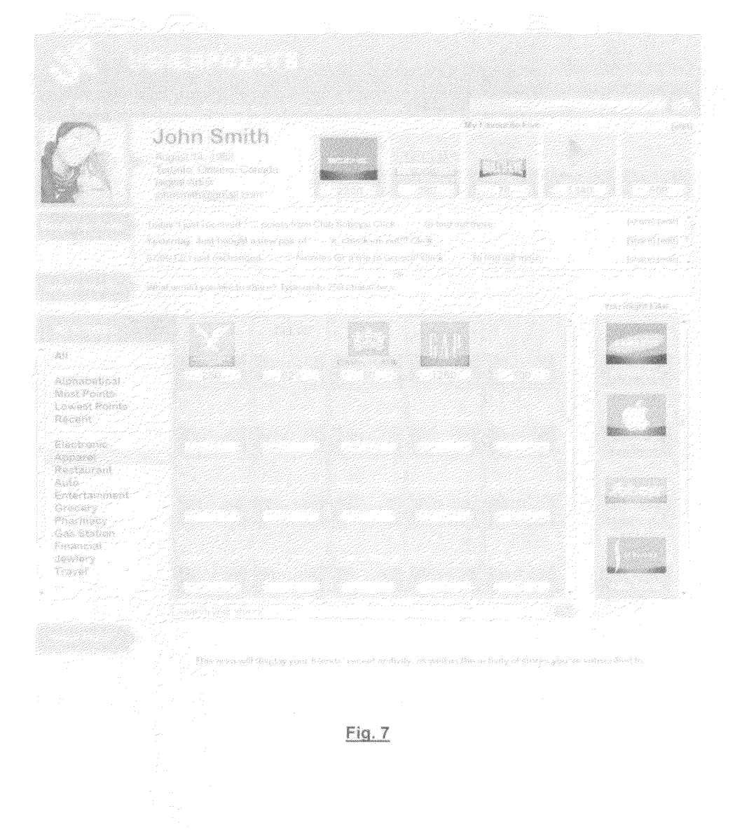

Reference is now made to FIGS. 1, 2, 3A, 3B, and 7. FIG. 7 shows a screen capture of a graphical user interface (GUI) that can be displayed on a display of a device, in accordance with at least one embodiment.

At 405, customer device 110 sends and system server 120 receives a request to upload customer loyalty point information to a social media profile. The request received from customer device 110 can be referred to as an upload request. The upload request can be transmitted via a communication link between one or more communication modules 206 as illustrated in FIG. 2, for example. System server 120 can, upon receiving an upload request at communication module 206, operate processor 202 to store the upload request in storage module 204 of system server 120 for further processing by processor 202 as illustrated in FIG. 2, for example.

Prior to sending an upload request on customer device 110, the sending customer will have completed a transaction with the merchant. For example, a transaction can be a purchase at the merchant's retail store.

The upload request sent to system server 120 in 405 includes information that system server 120 can use to upload loyalty points to a social media profile. For example, an upload request includes at least a customer identifier identifying the customer from the plurality of customers, a merchant identifier identifying the merchant in the plurality of merchants, and transaction data. System server 120 generates an upload record 350 to store the information contained in the upload request. Certain parameters in upload record 350 can be populated automatically by system server 120. For example, system server 120 can generate a unique identifier 351 for upload record 350, determine the date the upload request was received and record this date in 352 and assign an initial status 353 to upload record 350. System server 120 copies the customer and merchant identifiers contained in the upload request to 354 and 355 of upload record 350 respectively. Further, system server 120 copies any transaction data contained in the upload request received at 405 to 365 of upload record 350.

Status indicator 353 indicates the state of completion of a requested upload. For example, upload statuses can include a pending status, a cancelled status, a complete status or an invalid status. A pending status indicates that system server 120 has received an upload request and generated a corresponding upload record 350. A cancelled status indicates that a customer has cancelled the upload before the upload of loyalty points to a social media profile has occurred. A complete status indicates that an upload request has resulted in the successful upload of loyalty points to a social media profile. Finally, an invalid status indicates that the requested upload of loyalty points could not be completed by system server 120, for example in cases where system server 120 determines that a transfer request is not in compliance with the corresponding merchant rule set or where system server 120 is unable to retrieve transaction or product records from merchant server 140 that correspond with the transaction data 356 provided. Status indicator 353 can be updated as necessary by system server 120 during performance of an upload.

At 410, system server 120 accesses merchant server 140 and retrieves any transaction records that correspond to the transaction data specified in the upload request received in 405. To access merchant server 140, system server first 120 retrieves merchant record 320 corresponding with the merchant ID 355 in upload record 350. Next, system server 120 identifies the address of the merchant server 140 using merchant server address 328 of merchant record 320.

In at least one embodiment, system server 120 parses the data contained in transaction data 356 of upload record 350. System server 120 accesses merchant server 140 and retrieves any transaction and/or product records that correspond to the parsed transaction data 356. As described above, system server 120 can interact with merchant server 140 to obtain relevant transaction and/or product records corresponding to the parsed transaction data 356 using a protocol such as an API in known fashion.

If at 410 system server 120 has succeeded in retrieving one or more transaction records that correspond to the data indicated in the upload request received in 405, system server 120 proceeds to 415. If no transaction records are retrieved from merchant server 140 at step 410, system server 120 can, for example, send an error message for display on customer device 110 to notify customer 112 that an error has been encountered. Additionally, system server 120 can update status 353 in upload record 350 to reflect the failed upload attempt. In at least one embodiment, system server 120 communicates with customer device 110 via social media server 130 using a protocol such as an API in known fashion, as described above.

At 415, system server 120 generates a confirmation summary of the upload request. The confirmation summary is populated with transaction data and product data derived from the transaction and product record(s) retrieved from merchant server 140 in 410. In at least one embodiment, the confirmation summary includes a picture associated with the product or service purchased from the merchant. System server 120 sends the confirmation summary, including an option to proceed (for example, a button that can be clicked) for display on customer device 110.

At 420, system server 120 receives an indication from customer device 110 to proceed with the upload of customer loyalty data to the associated social media profile and proceeds to 425.

At 425, system server 120 determines if the upload request, now stored in upload record 350, complies with the merchant rule set. System server 120 retrieves rule set record 330 corresponding with merchant ID 353 from the plurality of merchant rule set records 330. System server 120 then compares the parameters of the upload record 350 to the rules contained in rule set 330.

If system server 120 determines, at 425, that the upload request adheres to the merchant rule set, then the method proceeds to 430. Conversely, if system server 120 discovers that the upload request does not adhere to the merchant rule set at 425, system server 120 can return an error message to be displayed on customer device 110. Additionally, system server 120 can update status 353 in upload record 350 to reflect the failed upload attempt.

At 430, system server 120 determines the social media profile associated with the customer identified in the upload request. System server 120 first locates the relevant social media record 340 using customer identifier 352 in upload record 350. In turn, system server 120 retrieves the social media profile ID 344 and social media profile address 346 from social media record 340.

At 435, system server 120 awards loyalty points to the uploading customer. Prior to awarding loyalty points, system server 120 calculates the number of loyalty points generated. For example, the calculation of loyalty points can be based on transaction data contained in the transaction record retrieved from merchant server 140, such as the price of the product and/or service purchased by the customer and exchange rule 337 contained in rule set record 330. Awarded loyalty points are added to the existing balance of loyalty points contained in the relevant customer loyalty membership entry in memberships 318.

Finally, at 440, system server 120 sends the information regarding the successful award of loyalty points to social media server 130 for display on the social media profile associated with the requesting customer. Additionally, system server 120 can update status 353 in upload record 350 to reflect the completion of the upload. An example of how the uploaded loyalty point information may be displayed on a social media profile is shown in FIG. 7, for example. As mentioned above, the uploaded loyalty point information can additionally include an image of the item purchased by the customer. Thus, in some embodiments, the GUI shown in FIG. 7 can be configured to display an image of the item purchased by the customer.

According to other embodiments of the present invention the order of these steps can be varied, or some steps may be dropped. For example, loyalty points could be awarded before any of the other steps are executed. Also, the customer social media profile can be determined immediately after a request is received to upload loyalty points to a social media profile. Optionally, in some embodiments, the step of retrieving a transaction record corresponding to an upload request from the merchant server can simply be dropped, if loyalty points have already been awarded. Instead of generating a confirmation summary and sending it to the customer device, the customer may provide confirmation in some other manner, or simply not provide confirmation at all. For example, a customer may provide confirmation at the time of the transaction, when the customer may indicate that they both accept the reward of loyalty points and authorize those loyalty points to be uploaded to their social media profile. Alternatively, if a customer does not provide authorization for these loyalty points to be uploaded to their social media profile, the customer could presumably simply remove these loyalty points from their social media profile as well as any advertisements. All of these various embodiments as well as others will readily be understood by those of skill in the art based on the foregoing description.

The upload of loyalty point data to a social media profile can be a valuable marketing activity for merchants. Thus, a merchant may wish to maximize the length of time that loyalty point data associated with their customer loyalty program is viewable on a social media profile. In at least one embodiment, system server 120 includes an indication of an amount of time the customer loyalty point information must remain viewable on a social media profile. That is, upon uploading loyalty point information to a social media profile, system server 120 can indicate how long the uploaded loyalty point information must remain viewable on the social media profile. After the indicated length of time has passed, the uploaded loyalty point information may be made unviewable on the social media profile (for example, by deleting or hiding the uploaded loyalty point information). The amount of time that the customer loyalty data must be viewable on a social media profile can be configured by storing a rule in a rule set record 330 for example.

In addition to uploading loyalty point data onto social media profiles, the uploading of a social media album containing product information (for example, the name of the product, and an image of the product etc.) associated with all of the products a customer has purchased from a merchant to the social media profile of the customer can also be a valuable marketing opportunity for merchants.

In at least one embodiment, system server 120 can receive a request to upload a social media album onto a social media profile. The request can be referred to as a social media album request. A social media album request may be sent by and received from customer device 110 for example. The social media album request contains at least a customer identifier and a merchant identifier. Upon receipt of the social media album request, system server 120 retrieves the upload records associated with the customer and merchant identified in the request by referencing the upload records 350 and identifying which upload records 350 bear the customer identifier 354 and merchant identifier 355 that correspond to the customer and merchant identified in the social media album request for example. Next, system server 120 narrows the set of retrieved upload records 350 by identifying which upload records 350 indicate that a product was purchased by the customer from the merchant. System server 120 may base this determination on status indicator 353 in upload record 350. For example, a complete status can indicate that loyalty points were awarded to a customer and uploaded to the social media profile of the customer as a result of a product being purchased by the customer.

After system server 120 has identified the upload records 350 that correspond with customer product purchases, system server 120 proceeds to generate a social media album. As discussed above, the social media album can contain product information (for example, pictures of the products purchased by the customer and the number of loyalty points awarded by the merchant) associated with all of the products the customer has purchased from the merchant. Optionally, information regarding products purchased some threshold time ago, such as a year ago or more, can be removed from the social media album, or stored in a historical purchase information portion, away from the current purchase information section.

To populate the social media album with product information, system server 120 can retrieve product information from each upload record 350 by retrieving the data stored in the product name 357 and product picture 358 fields of upload records 350 for example. System server 120 can retrieve the number of loyalty points awarded by retrieving the data stored in the points uploaded 359 field of upload records 350. System server 120 can further operate to include analytics data such as trends in a customer's purchasing and shopping habits, and the customer's preferred merchants and/or products in a social media album. System server 120 can generate analytics data based on the retrieved upload records 350 and/or transaction data stored on merchant server 140 for example.

In a variant embodiment, system server 120 can obtain the product information to be displayed in a social media album using the transaction data field 356 in upload records 350 to locate associated transaction and product records on merchant server 140.

Finally, system server 120 can send the generated social media album to social media server 130 for display on a social media profile. For example, the generated social media album can be sent to social media server 130 for display on the social media profile of the customer that sent the request to upload the social media album or to a different social media profile.

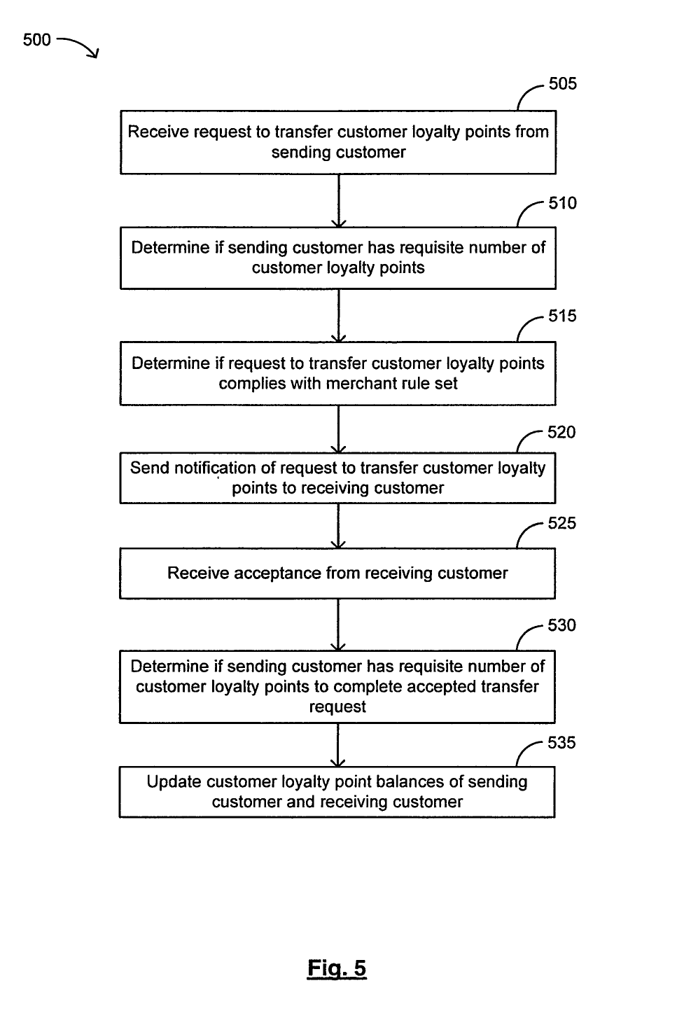

FIGS. 1, 2, 3A, 3C, 3D, 3F, 5, and 8 are now described to illustrate transferring loyalty points between two customers, in accordance with at least one embodiment.

As described above, a merchant can choose to permit a customer that possesses loyalty points from the merchant's customer loyalty program to transfer a quantity of their loyalty points to other customers. As will be described in detail below, loyalty points can be sent by a first customer and received by a second customer subject to rules contained in the rule set 330. The result of a transfer of loyalty points is that the balance of loyalty points held by the first customer is reduced by the number of points being transferred, and the corresponding balance of loyalty points held by the second customer is incremented by the number of loyalty points being transferred.

At 505, customer device 110 sends and system server 120 receives a request to transfer loyalty points from a first customer to a second customer. The request received from customer device 110 can be referred to as a transfer request. The transfer request can be transmitted via a communication link between one or more communication modules 206 as illustrated in FIG. 2 for example.

System server 120 can, upon receiving a transfer request at communication module 206, operate processor 202 to store the transfer request in storage module 204 of system server 120 for further processing by processor 202 as illustrated in FIG. 2, for example.

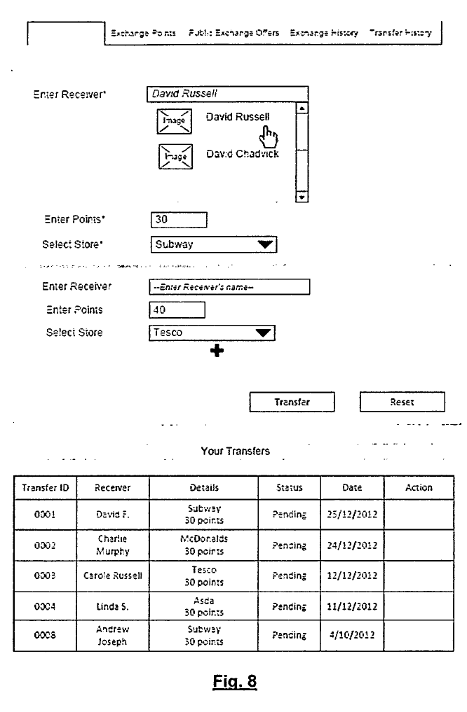

Prior to sending a transfer request on customer device 110, the first customer will generally have accumulated a balance of loyalty points in the customer loyalty program from which balance of loyalty points they wish to transfer a quantity of points to a second customer. A customer can accumulate a balance of loyalty points by purchasing products from the merchant administering a customer loyalty program, or by being the recipient of loyalty points transferred from another customer, for example. Customer 112 can enter the parameters of a transfer request on customer device 110 using a GUI, such as the example shown in FIG. 8, for example.

The transfer request sent to system server 120 in 505 includes information that system server 120 uses to transfer loyalty points of a customer loyalty program from the first customer to the second customer. For example, a transfer request includes at least a first customer identifier indicating the customer that shall send the loyalty points, a second customer identifier indicating the customer that shall receive the loyalty points being sent by the first customer, a merchant identifier indicating the customer loyalty program from which loyalty points are being transferred and an indication of the quantity of loyalty points to be transferred from the first customer to the second customer.

System server 120 generates a trade record 360 to store the information contained in the transfer request received at 505. Certain parameters in trade record 360 can be populated by system server 120 automatically. For example, system server 120 can generate a unique identifier 361 for trade record 360, determine the date the transfer request was received to record this date in 362 and assign an initial status 363 to trade record 360. System server 120 copies the first customer, second customer and merchant identifiers contained in the transfer request to 364, 365 and 366 respectively. In addition, system server 120 copies the indication of the quantity of points to be transferred contained in the transfer request to 367 of trade record 360.

Status indicator 363 in trade record 360 is used to indicate the state of completion of the requested transfer. For example, status 363 can be assigned a pending status, a cancelled status, an accepted status, a declined status or an invalid status. A pending status indicates that system server 120 has generated a trade record from a received transfer request. A cancelled status indicates that a first customer has cancelled the transfer before it has concluded. An accepted status indicates that a transfer has been accepted by the second customer. Finally, an invalid status indicates a transfer that could not be performed by system server 120 as requested, for example in cases where system server 120 determines that a transfer request is not in compliance with the corresponding merchant rule set. Status indicator 363 can be updated by system server 120 during performance of a transfer.

At 510, system server 120 determines if the first customer has a sufficient number of loyalty points to complete the transfer request sent in 505. System server 120 retrieves customer record 310 associated with the first customer using the first customer identifier 364 and then checks if the first customer possesses an amount of loyalty points equal to or greater than the number of loyalty points specified in the trade record 367. System server 120 can determine the balance of loyalty points in a particular customer loyalty program that the first customer has by using the merchant identifier 366 within the memberships 318 field of the customer record 310.

If at 510 system server 120 determines that the first customer does not possess a sufficient quantity of loyalty points to complete the transfer, system server 120 can return an error message for display on customer device 110.

If the first customer possesses sufficient points to enable the transfer, at 510, the method proceeds to 515. At 515, system server 120 determines if the transfer request complies with the rule set defined in rule set record 330. The relevant rule set record 330 is retrieved from the plurality of merchant rule set records using merchant identifier 366 in trade record 360.

In at least one embodiment, at 515, system server 120 determines whether one of or both the first customer and the second customer are in compliance with trading rule 333 in rule set record 330 associated with the merchant.

In at least one embodiment, the social media platform rule stipulates that the second customer must also be a member of the merchant's customer loyalty program.

In at least one embodiment, rule set 330 includes a connectivity rule 334 that must be satisfied by one of or both the first customer and the second customer before a transfer of loyalty points can occur. If system server 120 determines that either the social media profile of the first customer or the social media profile of the second customer or both has an insufficient number of connections to other social media profiles, the connectivity requirement will not be satisfied and the transfer of loyalty points cannot proceed. For example, system server 120 can reference the first and second customer identifiers (364 and 365) from trade record 360 and determine the social media record ID 342 for both customers. Next, system server 120 can determine the social media profile ID and address (344 and 346) from each social media record. System server 120 can determine if connectivity rule 334 is satisfied by comparing the number of connections that each social media profile has against the minimum number specified in connectivity rule 334.

In at least one embodiment, rule set 330 includes a traffic rule 335 that must be satisfied by one of or both the first customer and the second customer before a transfer of loyalty points can occur. If system server 120 determines that either the social media profile of the first customer or the social media profile of the second customer or both has an insufficient level of traffic, traffic rule 335 will not be satisfied and the transfer of loyalty points cannot proceed. For example, system server 120 can reference the first and second customer identifiers (364 and 365) from trade record 360 and can determine the social media record ID 342 for both customers. Next, system server 120 can determine the social media profile ID and address (344 and 346) from each social media record. System server 120 can determine if traffic rule 335 is satisfied by comparing the number of hits that each social media profile has against the minimum number specified in traffic rule 335.

In at least one embodiment, rule set 330 includes a usage rule 336 that must be satisfied by one of or both the first customer and the second customer before a transfer of loyalty points can occur. If system server 120 determines that either the social media profile of the first customer or the social media profile of the second customer or both has an insufficient level of usage, usage rule 336 will not be satisfied and the transfer of loyalty points cannot proceed. For example, system server 120 can reference the first and second customer identifiers (364 and 365) from trade record 360 and can determine the social media record ID 342 for both customers. Next, system server 120 can determine the social media profile ID and address (344 and 346) from each social media record. System server 120 can determine if usage rule 336 is satisfied by comparing the number of logins that each social media profile has against the minimum number specified in usage rule 335.

If, at 515, system server 120 determines that the rules defined in rule set 330 prohibit the transfer of loyalty points as requested in the transfer request and stored in trade record 360, system server 120 can return an error message to customer device 110 and update status indicator 363 associated with the transfer request to indicate an invalid status for example. Conversely, if system server 120 determines, at 515, that the transfer request adheres to each of the rules defined in rule set 330, then the method proceeds to 520.

At 520, system server 120 sends a notification of the request to transfer loyalty points to the second customer. The notification can include details such as the name of the first customer (obtained by referencing the customer name 314 component of customer record 310 associated with first customer ID 364 for example), the name of the merchant (obtained by referencing the merchant name 324 component of merchant record 320 associated with merchant ID 366 for example), an indication of the number of loyalty points to be transferred (367) and an option to accept (for example, a button that can be clicked) the transfer of loyalty points.

At 525, system server 120 receives an indication from the second customer to proceed with the transfer of loyalty points from the first customer to the second customer and proceeds to 525. Status indicator 363 can be updated by system server 120 to indicate an accepted status.

At 530, system server 120 confirms that the first customer has a sufficient number of loyalty points to complete the transfer request sent in 505 by following the procedure described in step 510. If at 530 system server 120 determines that the first customer does not have sufficient loyalty points to complete the transfer (because the first customer spent the loyalty points during the period of time occurring between 520 and 525 for example) system server 120 can return an error message for display on customer device 110 and update status indicator 363 to indicate an invalid status.

At 535, the loyalty point balances of the first customer and the second customer are updated to reflect the completed transfer. For example, the loyalty point balance of the first customer can be reduced by, and the loyalty point balance of the second customer can be incremented by, the number of points being transferred in the points 367 of trade record 360.

In at least one embodiment, system server 120 can send information regarding the successful transfer of loyalty points to social media server 130 for upload to the social media profiles associated with the first customer and the second customer. For example, the information uploaded to a social media profile upon completion of a transfer of loyalty points can contain the merchant's name and logo, the quantity of loyalty points used or received by the customers and/or other promotional material. Additionally, system server 120 can update status 353 in trade record 360 to reflect the completion of the transfer

According to other embodiments of the present invention the order of these steps can be varied, or some steps may be dropped. For example, the steps of notifying the second customer of a request to transfer loyalty points and receiving acceptance from the second customer to complete the transfer of loyalty points may simply be dropped so that loyalty points are transferred once requested by the first customer and without the second customer's approval. Optionally, in some embodiments, the step of determining if the first customer has the requisite number of loyalty points to complete the transfer may occur only once, for example just prior to completing the transfer of loyalty points. All of these various embodiments as well as others will readily be understood by those of skill in the art based on the foregoing description.

The upload of information relating to a completed transfer of loyalty points to a social media profile can be a valuable marketing activity for the merchant. Thus, a merchant may wish to maximize the length of time information relating to a transfer of loyalty points is viewable on a social media profile. In at least one embodiment, system server 120 includes an indication of an amount of time that information relating to a completed transfer of loyalty points must remain viewable on a social media profile. That is, upon completion of a transfer of loyalty points from a first customer to a second customer, system server 120 can indicate how long the loyalty point transfer information must remain viewable on the social media profiles of the first and/or second customers. After the indicated length of time has passed, the loyalty point transfer information can be removed from the social media profile(s). The amount of time that the loyalty point transfer information must be viewable on a social media profile can be configured by storing a rule in a rule set record 330 for example so that each of the plurality of merchants associated with a plurality of rule set records 330 can customize the amount of time the information relating to a transfer of loyalty points is to remain visible on a social media profile.

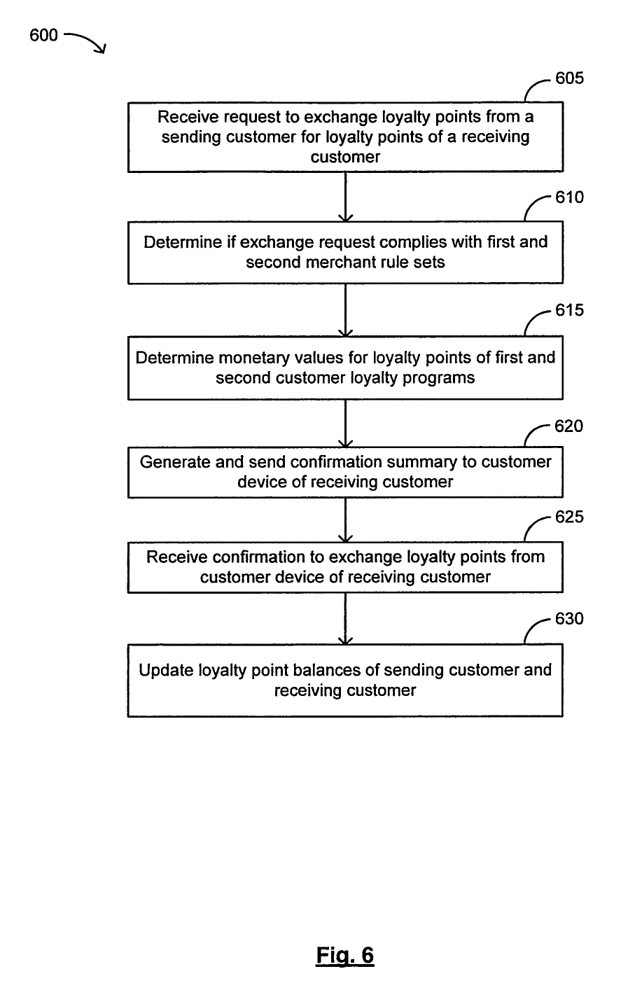

FIGS. 1, 2, 3A, 3C, 6, 9, 10 and 11 care now described to illustrate exchanging loyalty points between two customer loyalty programs and two customers, in accordance with at least one embodiment.

It will be understood that each merchant can choose to permit the exchange of loyalty points of their customer loyalty program. Specifically, an exchange of loyalty points consists of a related pair of loyalty points transfers. In an exchange, loyalty points of a first customer loyalty program belonging to a first customer are transferred to a second customer in exchange for the second customer transferring loyalty points of a second customer loyalty program to the first customer. A merchant can set preferences for the exchange of loyalty points from their associated customer loyalty program using trading rule 333 defined in rule set record 330 for example.

At 605, customer device 110 sends and system server 120 receives a request from a first customer to exchange a quantity of loyalty points from a first customer loyalty program for a quantity of loyalty points of a second customer loyalty program belonging to a second customer. The request received from the customer device 110 can be referred to as an exchange request. The exchange request can be transmitted via a communication link between one or more communication modules 206 as illustrated in FIG. 2 for example.

System server 120 can, upon receiving an exchange request at communication module 206, operate processor 202 to store the upload request in storage module 204 of system server 120 for further processing by processor 202 as illustrated in FIG. 2, for example.

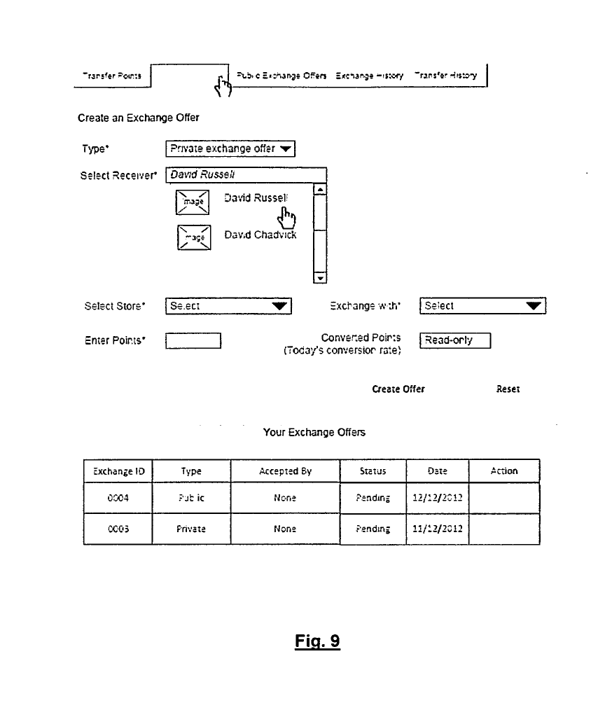

Prior to sending an exchange request on customer device 110, the first customer will generally have accumulated a balance of loyalty points in the customer loyalty program that they wish to exchange with a second customer. A customer can accumulate a balance of loyalty points in a merchant's customer loyalty program by completing purchase transactions with the merchant, for example. Customer 112 can enter the parameters of an exchange request on customer device 110 using a GUI, such as the example shown in FIG. 9, for example.

The exchange request sent to system server 120 at 605 includes information that system server 120 can use to exchange loyalty points of a first customer loyalty program belonging to a first customer for loyalty points of a second customer loyalty program belonging to a second customer. For example, an exchange request can include at least a first customer identifier, a second customer identifier, a first merchant identifier, a second merchant identifier, an indication of the quantity of first customer loyalty points to be exchanged and an indication of the quantity of second customer loyalty points to be exchanged.

System server 120 can generate a trade record 360 to store the information contained in the exchange request. Certain parameters in trade record 360 can be populated automatically by system server 120. For example, system server 120 can generate a unique identifier 361 for trade record 360, determine the date the exchange request was received and record this date in 362 and assign an initial status 363 to trade record 360.

Status indicator 363 in trade record 360 can be used to indicate the state of completion of the requested exchange. For example, status 363 can be assigned a pending status, a cancelled status, an accepted status, a declined status or an invalid status. A pending status indicates that system server 120 has generated a trade record from a received exchange request but the exchange request has yet to be completed. A cancelled status indicates that either of the first or second customers has cancelled the exchange of loyalty points before the exchange has been completed. An accepted status indicates that an exchange has been accepted by the second customer. A declined status indicates that an exchange has been declined by the second customer. Finally, an invalid status indicates a transfer that could not be performed by system server 120 as requested, for example in cases where system server 120 determines that a transfer request is not in compliance with the corresponding merchant rule set. Status indicator 363 can be updated by system server 120 during performance of an exchange of loyalty points.

System server 120 copies the first and second customer identifiers contained in the upload request to 364 and 365 of trade record 360 respectively. System server 120 copies the first and second merchant identifiers contained in the upload request to 366 and 368 of trade record 360 respectively. Further, system server 120 copies the first indication of the quantity of first customer loyalty points to be exchanged and the indication of the quantity of second customer loyalty points to be exchanged to 367 and 369 of trade record 360 respectively.

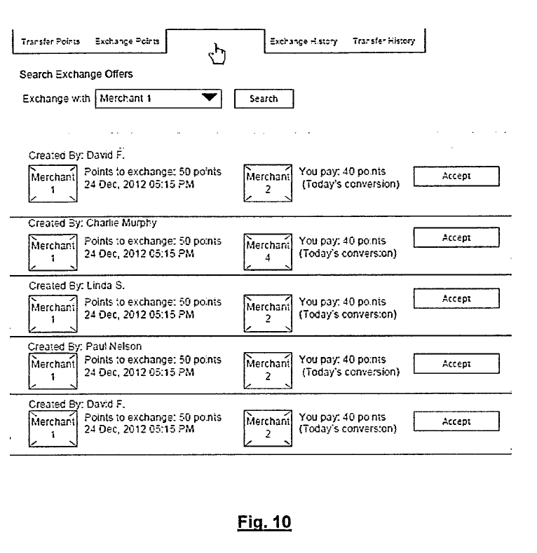

In a variant embodiment, system server 120 may store exchange requests that do not contain a second customer identifier. Such offers may be referred to as public exchange offers because the first customer is willing to exchange loyalty points with a second customer that may otherwise be a stranger to the first customer and vice versa. A customer may view public exchange offers that have been sent to system server 120 using a GUI, such as the example shown in FIG. 10, for example.

At 610, system server 120 retrieves the rule set records 330 for the first and second merchants (using identifiers 366 and 368 respectively) and determines if the exchange request, now stored in trade record 360 complies with each of the rules in the rule set records 330. For example, system server 120 can determine if the first and second customers are enrolled in the customer loyalty programs specified in the exchange request received at 605 and, further, assuming the first customer and the second customer are enrolled in the customer loyalty programs specified in the exchange request, system server 120 can determine that each of the first customer and the second customer has a sufficient number of loyalty points to complete the exchange of loyalty points.

To confirm that the first customer and the second customer are enrolled and have sufficient points in each of the customer loyalty programs specified in the exchange request, system server 120 can first retrieve the customer records 310 associated with the first customer and the second customer using the first customer identifier 364 and second customer identifier 365 in trade record 360.

System server 120 can then reference the membership 318 entry in the customer records 310 for each of the first customer and the second customer to determine the membership status and loyalty points balances for the first customer and the second customer. Next, system server 120 determines if each of the first customer and the second customer possess an amount of loyalty points equal to or greater than the number of loyalty points specified in the exchange request (367 and 369).

If, at 610, system server 120 determines that the rules contained in rule set 330 prohibit the exchange of loyalty points as requested in the exchange request as stored in trade record 360, system server 120 can return an error message to the customer device 110 of the first customer and/or the second customer. In addition, system server 120 can update the status indicator 363 associated with the exchange request in trade record 360 to reflect an invalid status. Conversely, if system server 120 determines, at 610, that the exchange request adheres to each of the rules in the rule set 330, then the method proceeds to 615.

At 615, system server 120 determines the monetary value of the loyalty points that the first customer wishes to exchange and the monetary value of the loyalty points that the second customer wishes to exchange. System server 120 can calculate the monetary value of the loyalty points tendered for exchange by a customer by referring to exchange rule 337 in rule set record 330, for example. After system server 120 has determined the monetary value of the first and second customer loyalty points to be exchanged, system server 120 proceeds to compare the monetary values of the first customer's loyalty points 367 with the monetary value of the loyalty points of the second customer 369.

If, at 615, system server 120 determines that the monetary value of the first customer loyalty points 367 is not equal to, or within some acceptable margin of, the monetary value of the second customer loyalty points 369, system server 120 can return an error message to the customer device 110 of the first and second customers and update status indicator 363 associated with the exchange request in trade record 360 to indicate that the exchange request was invalid. Conversely, if, at 615, system server 120 determines that the monetary value of the loyalty points of the first customer is equal to, or within an acceptable margin on, the monetary value of the loyalty points of the second customer, system server 120 proceeds to 620.

At 620, system server 120 generates a confirmation summary of the exchange request to the second customer. System server 120 can populate the confirmation summary with data from the exchange request (stored in trade record 360). System server 120 sends the confirmation summary, including options to proceed or decline (for example, buttons that can be clicked) for display on the customer device 110 of the second customer.

At 625, system server 120 receives an indication from the customer device 110 of the second customer to proceed with the exchange of loyalty points as described in the confirmation request sent in 620 and proceeds to 630. If, at 625, the second customer declines the exchange request as outlined in the confirmation summary sent in 620, system server 120 can update the status indicator 363 associated with the exchange request to indicate a declined status.

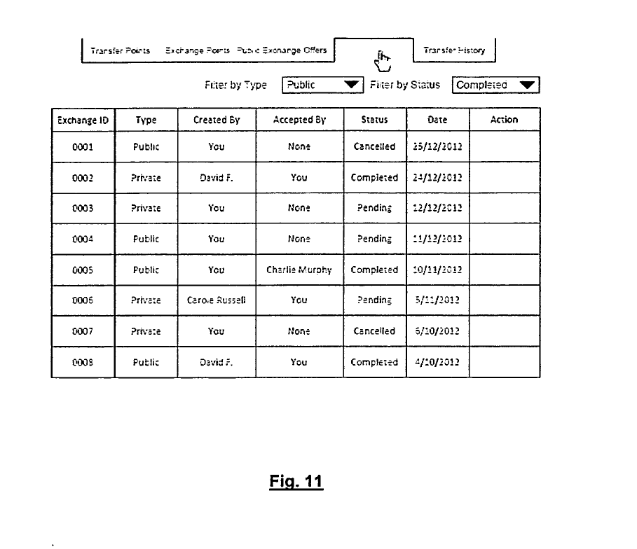

At 630, system server 120 updates the loyalty point balances of the first customer and the second customer to reflect the completed exchange. If system server 120 cannot update the loyalty point balances of the first and second customers (for example where the loyalty points balance of one of or both of the first and second customers has decreased to a level insufficient to complete the exchange during the period of time occurring between 620 and 625), system server 120 can return an error message for display on customer device 110 and update the status indicator 363 associated with the exchange request to reflect an invalid status. A customer may view completed exchanges of loyalty points to which they have been a party by viewing a GUI, such as the example shown in FIG. 11, for example.

In at least one embodiment, system server 120 can send information regarding the successful exchange of loyalty points between the first and second customers to social media server 130 for upload to the social media profiles associated with the first customer and the second customer. For example, the information uploaded to a social media profile upon completion of an exchange of loyalty points can contain the merchant's name and logo, the quantity of loyalty points used or received by the customers and/or other promotional material. Additionally, system server 120 can update status 353 in trade record 360 to reflect the completion of the exchange.

The upload of information relating to a completed exchange of loyalty points to a social media profile can be a valuable marketing activity for the merchant. Thus, a merchant may wish to maximize the length of time information relating to an exchange of loyalty points is viewable on a social media profile. In at least one embodiment, system server 120 includes an indication of an amount of time the information relating to a completed transfer of loyalty points must remain viewable on a social media profile. That is, upon completion of an exchange of loyalty points between a first customer and a second customer, system server 120 can indicate how long the loyalty point exchange information must remain viewable on the social media profiles of the first and/or second customers. After the indicated length of time has passed, the loyalty point transfer information can be removed from the social media profile. The amount of time that the loyalty point transfer information must be viewable on a social media profile can be configured by storing a rule in a rule set record 330 for example so that each of the plurality of merchants associated with a plurality of rule set records 330 can customize the amount of time the information relating to a transfer of loyalty points is to remain visible on a social media profile

According to other embodiments of the present invention, the order of these steps can be varied, or some steps may be dropped. For example, the step of determining monetary values for loyalty points may be skipped and the loyalty points freely exchanged between the first and second customer. All of these various embodiments as well as others will readily be understood by those of skill in the art based on the foregoing description.

1. A computer-implemented method for providing a plurality of loyalty programs for a plurality of merchants, the method comprising:
storing on a computer-readable storage module, identification information for a plurality of merchants and a plurality of customers, and a plurality of rule sets for the plurality of merchants such that each merchant in the plurality of merchants has a corresponding rule set defining a corresponding loyalty program for that merchant;
receiving, at a communication module linked for communication with the computer-readable storage module, a request from a customer in the plurality of customers, wherein the request identifies the customer, a merchant in the plurality of merchants, and purchase information regarding a purchase made by that customer from that merchant;
operating a processor to determine if the request received by the customer complies with the corresponding rule set for that merchant, the processor being linked to the communication module and the computer-readable storage module for communication therewith;
if the processor determines that the request complies with the rule set, then operating the processor to determine a social media profile for the customer, and awarding loyalty points to the customer based on at least the purchase information, and uploading loyalty point reward information to the social media profile for the customer, wherein the uploaded loyalty point reward information is viewable at the social media profile for the customer.

2. The method as defined in claim 1 further comprising storing on the computer-readable storage module, a plurality of social media records for the plurality of customers such that each customer in the plurality of customers has a corresponding social media record in the plurality of social media records, and the corresponding social media record identifies a social media profile identifier, wherein operating the processor to determine the social media profile for the customer comprises locating the corresponding social media record for that customer.

3. The method as defined in claim 2 wherein each rule set in the plurality of rule sets includes a social media platform rule defining at least one social media platform, and operating the processor to determine if the request received from the customer complies with the corresponding rule set for that merchant comprises determining if the social media profile record for that customer identifies a social media platform identified by the social media platform rule.

4. The method as defined in claim 3 wherein each rule set in the plurality of rule sets further includes a trading rule defining when loyalty points for that merchant may be traded for loyalty points of a second merchant in the plurality of merchants awarded to a second customer in the plurality of customers.

5. The method as defined in claim 4 wherein the trading rule for that merchant requires the second customer to have a social media profile identified by the social media platform rule for that merchant.

6. The method as defined in claim 4 wherein the trading rule for that merchant requires the purchase information to be displayed at the social media profile for both the customer and the second customer after the trade is completed.

7. The method as defined in claim 1 wherein the purchase information comprises product information for a product purchased by the customer from the merchant, the product information being uploaded and viewable at the social media profile for the customer.

8. The method as defined in claim 7 wherein the product information comprises a picture of the product purchased by the customer, and the picture of the product is viewable at the social media profile for the customer.

9. The method as defined in claim 1 further comprising
receiving a search request identifying at least one of a product, and a customer in the plurality of customers, and
operating the processor to search for a social media profile identifying at least one of the product and the customer.

10. The method as defined in claim 9 wherein the search request identifies both the product, and the customer in the plurality of customers, and operating the processor to search for the social media profile identifying at least one of the product and the customer comprises operating the processor to search for the social media profile identifying the product and the customer.

11. The method as defined in claim 1 further comprising maintaining the loyalty point reward information uploaded and viewable at the social media profile for the customer for a pre-determined time.

12. The method as defined in claim 1 wherein storing on the computer-readable storage module, identification information for the plurality of merchants and the plurality of customers comprises
storing on the computer-readable storage module, identification information for a plurality of unique merchant identifiers for the plurality of merchants such that each merchant in the plurality of merchants has a corresponding unique merchant identifier; and
storing on the computer-readable storage module, a plurality of unique customer identifiers for a plurality of customers such that each customer in the plurality of customers has a corresponding unique customer identifier.

13. The method of claim 8 further comprising
receiving a social media album request identifying at least a customer in the plurality of customers and a merchant in the plurality of merchants,
operating the processor to generate a social media album wherein the social media album contains a picture for each of one or more products purchased from the merchant by the customer, and
uploading the social media album to the social media profile of the customer.

14. A computer system for providing a plurality of loyalty programs for a plurality of merchants, the computer system comprising:
a computer-readable storage module configured to store identification information for a plurality of merchants and a plurality of customers, and a plurality of rule sets for the plurality of merchants such that each merchant in the plurality of merchants has a corresponding rule set defining a corresponding loyalty program for that merchant, the computer readable storage module being configured to store the identification record for that merchant in linked relation with the corresponding rule set for that merchant such that the corresponding rule set can be determined from the identification information for that merchant;
a communication module linked for communication with the computer-readable storage module, the communication module being configured to receive a request from a customer in the plurality of customers, wherein the request identifies the customer, a merchant in the plurality of merchants, and purchase information regarding a purchase made by that customer from that merchant;
a processor configured to determine if the request received by the customer complies with the corresponding rule set for that merchant, the processor being linked to the communication module and the computer-readable storage module for communication therewith;
wherein if the processor determines that the request complies with the rule set, then the processor is further configured to determine a social media profile for the customer, and award loyalty points to the customer based on at least the purchase information, and upload loyalty point reward information to the social media profile for the customer, wherein the uploaded loyalty point reward information is viewable at the social media profile for the customer.

15. The computer system as defined in claim 14 wherein the computer-readable storage module is further configured to store a plurality of social media records for the plurality of customers such that each customer in the plurality of customers has a corresponding social media record in the plurality of social media records, and the corresponding social media record identifies a social media profile identifier, wherein the processor is configured to locate the corresponding social media record for that customer when determining the social media profile for the customer.

16. The computer system as defined in claim 15 wherein each rule set in the plurality of rule sets includes a social media platform rule defining at least one social media platform, and the processor is configured to determine if the social media profile record for that customer identifies a social media platform identified by the social media platform rule when determining if the request received from the customer complies with the corresponding rule set for that merchant.

17. The computer system as defined in claim 16 wherein each rule set in the plurality of rule sets further includes a trading rule defining when loyalty points for that merchant may be traded for loyalty points of a second merchant in the plurality of merchants awarded to a second customer in the plurality of customers.

18. The computer system as defined in claim 17 wherein the trading rule for that merchant requires the second customer to have a social media profile identified by the social media platform rule for that merchant.

19. The computer system as defined in claim 17 wherein the trading rule for that merchant requires the purchase information to be displayed at the social media profile for both the customer and the second customer after the trade is completed.

20. The computer system as defined in claim 14 wherein the purchase information comprises product information for a product purchased by the customer from the merchant, the product information being uploaded and viewable at the social media profile for the customer.

21. The computer system as defined in claim 20 wherein the product information comprises a picture of the product purchased by the customer, and the picture of the product is viewable at the social media profile for the customer.

22. The computer system as defined in claim 14 wherein
the communication module is further configured to receive a search request identifying at least one of a product, and a customer in the plurality of customers, and
the processor is further configured to search for a social media profile identifying at least one of the product and the customer.

23. The computer system as defined in claim 22 wherein the search request identifies both the product, and the customer in the plurality of customers, and the processor is further configured to search for the social media profile identifying at least one of the product and the customer.

24. The computer system as defined in claim 14 wherein the processor is further configured to maintain the loyalty point reward information uploaded and viewable at the social media profile for the customer for a pre-determined time.

25. The computer system as defined in claim 14 wherein the computer-readable storage module is configured to store identification information for the plurality of merchants and the plurality of customers comprising
a plurality of unique merchant identifiers for the plurality of merchants such that each merchant in the plurality of merchants has a corresponding unique merchant identifier; and
a plurality of unique customer identifiers for a plurality of customers such that each customer in the plurality of customers has a corresponding unique customer identifier.

26. The computer system as defined in claim 21 wherein
the communication module is further configured to receive a social media album request identifying at least a customer in the plurality of customers and a merchant in the plurality of merchants, and
the processor is further configured to
generate a social media album wherein the social media album contains a picture for each of one or more products purchased from the merchant by the customer, and
to upload the social media album to the social media profile of the customer.
